(19) United States
(12) Patent Application Publication
(10) Pub. No.: US 2019/0378009 A1
(43) Pub. Date: Dec. 12, 2019

(54) METHOD AND ELECTRONIC DEVICE FOR CLASSIFYING AN INPUT

(71) Applicant: Nokia Technologies OY, Espoo (FI)

(72) Inventors: Carl NUZMAN, Union, NJ (US); Shirin JALALI, Weehawken, NJ (US); lraj SANIEE, New Providence, NJ (US)

(73) Assignee: Nokia Technologies OY, Espoo (FI)

(21) Appl. No.: 16/006,099

(22) Filed: Jun. 12, 2018

(51) Int. Cl. G06N 3/08; G06N 3/04

(52) U.S. Cl. CPC G06N 3/08; G06N 3/04

(57) ABSTRACT

A method including, at a processor, obtaining an input to be classified, training a neural network, and classifying the input using the trained neural network. The training of the neural network being done in a feed-forward manner based on a plurality of sample inputs and sample classifications. Each of the sample classifications is associated with one of the plurality of sample inputs. The training includes, for each of a plurality of layers in the neural network, selecting values for a weight matrix, parameters for a plurality of activation unit functions, and a plurality of linear filter parameters. The classifying the input using the trained neural network is based on the weight matrix, the parameters for the plurality of activation unit functions, and the plurality of linear filter parameters for each of the plurality of layers.

### TECHNICAL FIELD

One or more example embodiments relate to machine learning and neural network training.

### BACKGROUND

In recent years, breakthroughs in computing hardware and training algorithms have led to successful applications of Deep Neural Nets (DNN), in which the network consists of hidden nodes organized into tens of thousands of levels and tens or even hundreds of trained layers. However, training a DNN requires a large amount of computation to improve or optimize the large number of weights connecting the hidden nodes. The optimization involves minimizing a cost function iteratively by backpropagation (stochastic gradient descent). These backpropagation training methods generally require more computational power than is feasible for implementation on most consumer electronics such as desktops, laptops, and smartphones.

DNNs also have many meta-parameters that affect performance. These include structural parameters (number of layers, number of hidden nodes per layer) and algorithmic parameters, such as learning rate, initialization method, choice of objective functions, and parameters of the gradient descent algorithm, among others. The need to tune the meta-parameters through many iterations of training and validation provides additional multiplicative factors to the computational load associated with training, without an explicit trade-off between desired classification accuracy and complexity.

### SUMMARY

One or more example embodiments relate to a method for training a neural network and classifying an input using the neural network.

At least one example embodiment of the inventive concepts discloses a method including obtaining an input to be classified, training a neural network, and classifying the input using the trained neural network. The training of the neural network is done in a feed-forward manner based on a plurality of sample inputs and sample classifications. Each of the sample classifications is associated with one of the plurality of sample inputs. The training includes, for each of a plurality of layers in the neural network, selecting values for a weight matrix, parameters for a plurality of activation unit functions, and a plurality of linear filter parameters. The classifying the input using the trained neural network is based on the weight matrix, the parameters for the plurality of activation unit functions, and the plurality of linear filter parameters for each of the plurality of layers.

At least one example embodiment of the inventive concepts discloses an electronic device including a memory configured to store program instruction, and a processor configured to execute the program instruction. The memory, the processor, and the program instructions are configured to obtain an input to be classified, train a neural network, and classify the input using the neural network. The training of the neural network is done in a feed-forward manner based on a plurality of sample inputs and sample classifications. Each of the sample classifications is associated with one of the plurality of sample inputs. The training includes, for each of a plurality of layers in the neural network, selecting values for a weight matrix, parameters for a plurality of activation unit functions, and a plurality of linear filter parameters. The classifying the input using the trained neural network is based on the weight matrix, the parameters for the plurality of activation unit functions, and the plurality of linear filter parameters for each of the plurality of layers.

At least one example embodiment of the inventive concepts discloses a non-volatile computer readable medium including program instructions which, when executed by a processor, cause the processor to obtain an input to be classified, train a neural network, and classify the input using the neural network. The training of the neural network is done in a feed-forward manner based on a plurality of sample inputs and sample classifications. Each of the sample classifications is associated with one of the plurality of sample inputs. The training includes, for each of a plurality of layers in the neural network, selecting values for a weight matrix, parameters for a plurality of activation unit functions, and a plurality of linear filter parameters. The classifying the input using the trained neural network is based on the weight matrix, the parameters for the plurality of activation unit functions, and the plurality of linear filter parameters for each of the plurality of layers.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a block diagram illustrating an example electronic device according to some example embodiments.

FIG. 2 is a flow diagram illustrating example computational operations performed to classify an input according to some example embodiments.

FIG. 3 is a block diagram illustrating an example neural network according to some example embodiments.

FIG. 4 is a block diagram illustrating an example computation block according to some example embodiments.

FIG. 5 is a flow diagram illustrating example computational operations performed during training of a neural network according to some example embodiments.

FIG. 6 is a flow diagram illustrating example computational operations performed to classify an input using a trained neural network according to some example embodiments.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

Accordingly, it should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the Figures.

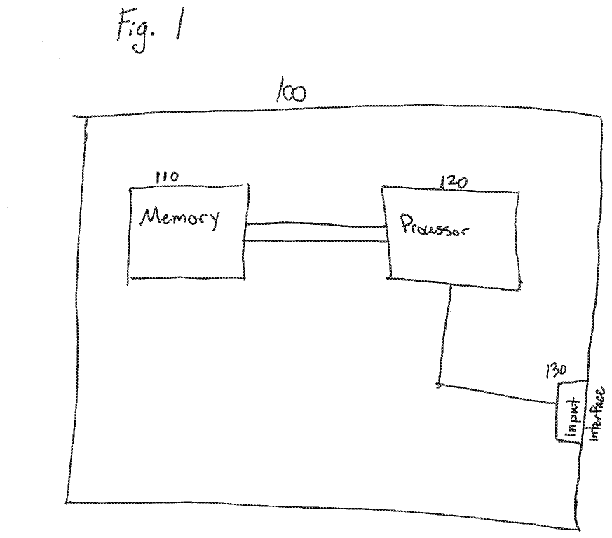

FIG. 1 is a block diagram illustrating an electronic device 100. The electronic device 100 may include a memory 110, a processor 120, and an input interface 130. The Electronic device may be or include a computer, a server, a smart phone, a tablet, etc. The electronic device may store program instruction for implementing a neural network, training the neural network and classifying inputs using the trained neural network. The processor 120 may execute the program instructions stored in the memory 110, to implementing the neural network, training the neural network, and classifying inputs using the trained neural network. The electronic device 100 may receive sample inputs or inputs to be classified through the input interface 130. The memory 110 may store the sample inputs and inputs to be classified. The electronic device 100 may also include more than one memory, processor, or input interface.

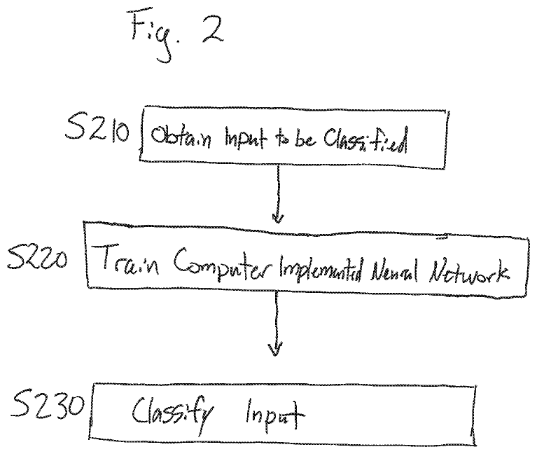

FIG. 2 is a flow diagram illustrating example computational operations performed by the processor 120 to classify an input. The process may include obtaining an input to be classified, at S210, training a neural network, at S220, and classifying an input, at S230. In the case where the neural network may have already been trained based on a previous input or in anticipation of an input to be classified, operation S220 may be performed before operation S210.

The obtaining of the input to be classified, at S210, may take different forms, for example if a picture is to be classified the input interface 130 may be a camera or a port connected electronically to a camera by which a picture is received. If a sound clip is to be classified the input interface 130 may be a microphone or a port electronically connected to a microphone which obtains the sound clip. The input interface 130 may also be a port through which an input to be classified is obtained from another electronic device. The obtaining of the input to be classified, at S210, may also be performed by retrieving the input to be classified from the memory 110, or generating the input to be classified by the processor 120.

The obtaining of the input to be classified, at S210, may also include modifying a size, scale, or form of data in order to obtain an input to be classified that can be processed in a trained neural network by the processor 120. For example, if the input to be classified is a picture, training samples for the desired classification may only be available for a 100 by 100 pixel picture. Accordingly, the obtaining of the input to be classified may include scaling or cropping the picture to 100 by 100 pixels. As another example, if the input to be classified is a sound clip, training samples for the desired classification may only be available for a Fourier transform of a one second clip. Accordingly, the obtaining of the input to be classified my include cropping the sound clip to one second and taking a Fast Fourier transform of the sound clip.

The obtaining of the input to be classified, at S210, may also include receiving a request to classify the input by the processor 120. The request to classify the input may include a classification or classifications. For example, if the input is a picture, a request to perform a binary classification of the picture as a picture of a tree or not a picture of a tree may be received by the processor 120.

The input vector for the neural network may require a sequential order of input values to be included in the input vector. Accordingly, the obtaining of the input to be classified, at S210 may also include rearranging data to form an input vector by the processor 120.

As will be described in further detail below, the training the neural network, at S220, may include processing a plurality of training samples in a feed-forward manner by executing program instruction stored on the memory 110 using the processor 120. Each of the training samples are associated with a sample classification. The training samples may have the same number of values in an input vector as the input to be classified. The training may include, for each of a plurality of layers in the neural network, selecting values for a weight matrix, parameters for a plurality of activation unit functions, and a plurality of linear filter parameters. The training may also include, for an N-th layer among the plurality of layers of the neural network, selecting a decision threshold for determining a classification of the input.

After the neural network is trained, at S220, the electronic device 100 may implement the trained neural network using, for each of the layers of the neural network, the selected values for the weight matrix, the parameters for the plurality of activation unit functions, and the plurality of linear filter parameters in order to classify the input, at S230, by executing program instructions stored in the memory 110 by the processor 120. These operations will be discussed in further detail below.

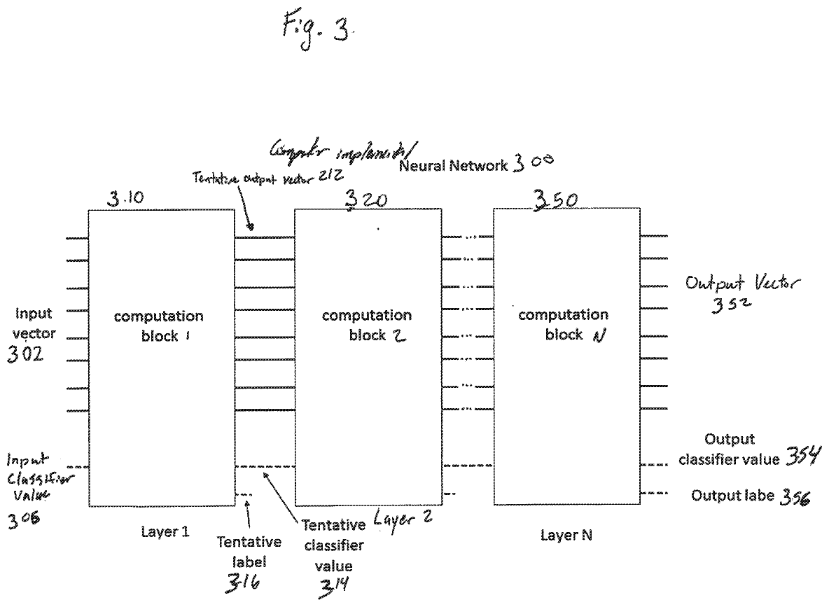

FIG. 3 is a block diagram illustrating a neural network 300. Namely, FIG. 3 illustrates the configuration of the processor 120 based on the processor 120 having executed program instructions to implement the neural network 300. The neural network may include a plurality of computation blocks. For example, as illustrated in FIG. 3 the neural network may include “N” computation blocks. Computation block 1 310 may be a first layer of the neural network, computation block 2 320 may be a second layer of the neural network, and computation block N 350 may be an N-th layer of the neural network.

When the neural network is classifying an input, each of the computation blocks may input an input vector and an input classifier value and output an output vector, an output classifier value, and an output label. When the neural network is being trained, each of the computation blocks may input a plurality of input vectors, a plurality of classifier values, and the training samples, and output, a plurality of output vectors, a plurality of output classifier values, and a plurality of output labels.

Computation block 1 310 may input an input vector 302 based on an input to be classified or a training sample. The input classifier value 306 input into computation block 1 310 may be set to ‘0,’ ‘1,’ or may be based on the input to be classified or the training sample. Computation block 1 310 may output a tentative output vector 312. Tentative output vector 312 may have the same number of values as the number of values in the input vector 302 or may include a different number of values. Computation block 1 310 may also output a tentative classifier value 214 and a tentative label 216.

Computation block 2 320 may input the tentative output vector 312 as an input vector and tentative classifier value 314 as an input classifier value. The output vector and output classifier value of computation block 2 320 may then be used by the next computation block. This process of the outputs of one computation block being used as the inputs of the next computation block continues until computation block N.

Computation block N 350 receives the output vector and output classifier value from the previous block as the input vector and input classifier value respectively. Computation block N may output an output vector 352, an output classifier value 354, and an output label 356. The output classifier label may take many forms. For example, the output label 356 may be a ‘0’ or ‘1’ if the classification is binary or may be a value indicating a classification category if the classification is not binary. As will be explained in further detail below, when the output label 356 is not binary, each of the computation blocks may output more than one output classifier value. Each of the more than one output classifier value may correlate to one of the non-binary classifications.

Additionally, the classifications may be made in a binary tree format, where several neural networks are trained such that the input can be classified based on binary classifications. For example, for an input to be classified between three classifications, two neural networks may be trained. The first neural network may be trained for a binary classification between a first classification among the three classifications and a set of the second and third classification among the three classifications. The second neural network may be trained for a binary classification between the second classification and the third classification. Accordingly, an input to be classified can be classified using the first neural network between the first classification and the set of the second classification and the third classification. If the first neural network returns a classification of the set of the second and third classifications, the processor 120 may then classify the input using the second neural network to classify between the second classification and the third classification. In this manner the processor may use the binary tree format to classify between more than two categories.

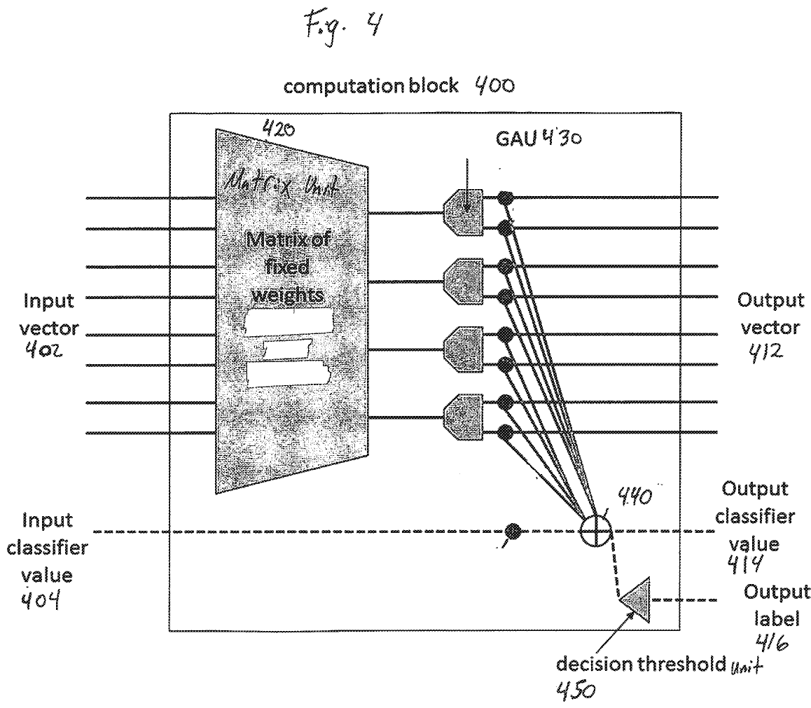

FIG. 4 is a block diagram illustrating a computation block 400. The computation block may be implemented by the processor 120 executing program instruction stored on the memory 110. Namely, FIG. 4 illustrates the configuration of the processor 120 having executed program instructions to implement the computation block 400. The computation block may include a matrix unit 420, Generalized Activation Units (GAUs) 430, linear filter 440, and a decision threshold unit 450.

Computation block 400 may input an input vector 402 and input classifier value 404. Computation block 400 may output an output vector 412, output classifier value 414, and output label 416.

During training, the computation block may process all of the operations related to each of the unit types together before processing any of the operations related to the other units. For example, during training, the computation block 400 may process all of the operations related to the matrix unit 420 before any of the outputs of the matrix unit 420 are processed by one of the GAUs 430. When the neural network is trained, the computation block 400 may process each of the inputs separately.

The matrix unit 420 may include a matrix of fixed weights. The input vector may include a plurality of values as represented by the plurality of input lines into the matrix unit 420 in FIG. 3. The matrix unit 420 may apply the matrix of fixed weights to the input vector 302 by performing matrix multiplication. Based on the dimensions of the matrix of fixed weights, the output of the matrix unit may include a different number of values than the input vector 402. For example, as shown in FIG. 4 the matrix unit output vector of the matrix unit 420 may include half as many values as the input vector 402.

The GAU 430 may perform one or more functions on one of the values of the output of the matrix unit 420 based on parameters of the GAU 430. Each of the GAUs 430 may have different parameters. Each GAU 430 may output one or more outputs. For example, as shown in FIG. 4 each of the GAUs 430 may output two values. The outputs of all of the GAUs 430 associated with one input vector 402 may form the output vector 412.

The linear filter 440 may generate the output classifier value 414 based on the output vector 412 and the input classifier value 404. For example, the linear filter 440 may multiply one of the outputs from the GAUs that makes up the output vector 412 or the input classifier value 404 by a linear scalar value to generate a summand. If the classification is non-binary, the linear filter 440 may generate multiple summands associated with the same value of the output vector 412 or input classifier value 404 based on multiple linear classifying values, where each of the multiple linear classifying values may correlate to one of the classifications.

The linear filter 440 may generate the output classifier value 414 based on the summands. For example, the linear filter 440 may generate the output classifier value 414 by summing the summands. If the classification is non-binary the linear filter 440 may generate multiple output classifier values 414 associated with each input vector, where each of the multiple output classifier values 414 may correlate to one of the non-binary classifications.

The decision threshold unit 450 may generate the output label 416 associated with each input vector 402 based on the output classifier value 414 and a decision threshold. For example, if the classification is binary, the decision threshold unit 450 may generate an output label 416 of ‘1’ if the output classifier value is greater than or equal to the decision threshold, and may otherwise output an output label 416 of ‘0.’

As another example, if the classification is non-binary and there are three classifications, the decision threshold unit 450 may generate an output label 416 of ‘11’ if the third classification is the greatest of the output classification values, the decision threshold unit 450 may generate an output label 416 of ‘10’ if the second classification is the greatest of the output classification values, or the decision threshold unit 450 may generate an output label 416 of ‘01’ if the first is the greatest of the output classification values. Accordingly, the decision threshold unit 450 may generate an output label 416 associated with the classification with the greatest classification value. Optionally, the decision threshold unit may also output an output label 416 based on a decision threshold. For example, the decision threshold unit 450 may compare the greatest of the output classification values with a decision threshold and output an output label 416 of ‘00’ if the greatest of the output classification values is less than the decision threshold. The decision threshold may be particular to the output classification value being compared to the decision threshold or may be the same decision threshold for each of the output classification values.

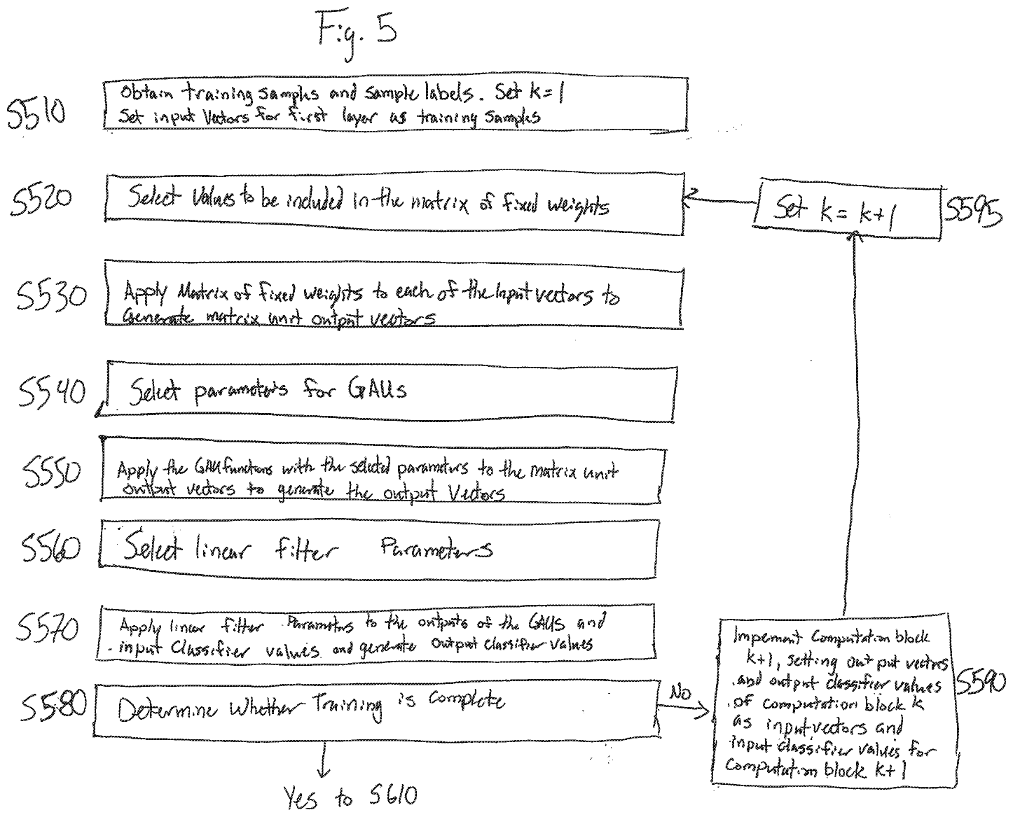

FIG. 5 is a flow diagram illustrating example computational operations performed during training of the neural network 300. The processor 120 may obtain training samples and sample labels and set a value of k equal to 1, at S510. Each of the sample labels may correspond to one of the training samples. The value k may represent a layer at which the training is taking place. As discussed above, the training samples may be associated with a request for classifying an input and the sample labels may represent classifications performed previously by a person or by another neural network. In this manner, the training of the neural network 300 may be a form of supervised machine learning. For example, if the request to classify the input is to classify an input picture as being of a tree or not being of a tree, the processor 120 may obtain 100 training samples based on pictures that have a sample label indicating that the pictures are of trees and may obtain 100 training samples based on pictures with the sample labels indicating the pictures are not of trees and may use those 200 training samples to train the neural network. As another example, if the request is to classify a sound clip as the call of one of 10 birds, the processor 120 may obtain training samples with sample labels indicating one of the 10 different bird calls, such that training samples are obtained for each of the 10 different bird calls.

The processor 120 may also set the training samples as input vectors 302 for the first computation block (for example, computation block 1 310) and ‘0’ as the input classifier values 306 for first computation block, at S510.

The processor 120 may select values to be included in the matrix of fixed weights, at S520. The processor 120 may determine the dimensions of the matrix of fixed weights based on the number of values included in the input vector 402. For example, if the input vector 402 includes z values, the input vector may be arranged by the processor 120 as a z by 1 matrix, at S510. The processor 120 may determine the dimensions of the matrix of fixed values to be z/2 by z, such that the matrix output vector includes half as many values as the input vector 402. In other example embodiment, the processor 120 may determine the dimensions of the matrix of fixed values to be z by z, such that the matrix output vector includes as many values as the input vector 402. The dimensions of the matrixes of fixed weights for different computational blocks may be different. The values to be included in the matrix of fixed weights may be selected at random using a Gaussian distribution centered on ‘0.’ The values to be included in the matrix of fixed weights may also be selected using another random probabilistic method, or using a desired (or, alternatively predetermined) matrix. Accordingly, the values of the weight matrix may be selected independently of the sample inputs and sample labels.

After the values to be included in the matrix of fixed weights have been selected, the processor 120 may implement the matrix unit 420, such that the matrix of fixed weights is applied to each of the input vectors and a plurality of matrix unit output vectors are generated, at S530. Each of the matrix unit output vectors corresponds to one of the input vectors. Each of the matrix unit output vectors includes a plurality of matrix unit output values.

The processor 120 may select parameters for the GAUs, at S540. A number of possible parameterized activation functions and parameter selection rules can be formulated. For example, each GAU may use a two parameter ReLu-based activation function with parameters τ (a threshold) and s (a scale value), of the form f(x;τ,s)=max(s(x−t), 0). A GAU 430 with M outputs implements M function f(x;τ_{y},s_{y})=max(s_{y}(x−τ_{y}), 0) for y=1, . . . , M. During training, a given GAU 430 has access to a list of labelled pairs where (xᵢ, cᵢ) is associated with training sample i, where the value xᵢ is the scalar input to the GAU 430 from the matrix unit 420, and cᵢ is the corresponding sample label. Some examples of rules for choosing threshold values τ for a GAU include the following.

Random pair midpoint: Let τ=(xᵢ+xⱼ)/2 be the midpoint of two randomly selected sample values xᵢ and xⱼ to be input to the GAU. In an example embodiment, the samples are chosen without regard to a classification associated with the associated training sample; in another version, the different example embodiments, the sample xᵢ is selected to always be associated with the opposite classification as xⱼ such that cⱼ=1−cᵢ of the first sample, in the case of a binary classification. In yet another example embodiment, the second sample is always selected to be associated with a training sample associated with the same classification of the first sample such that cⱼ=cᵢ.

Trough: The scalar distribution of each class is estimated, for example from a Gaussian mixture model, and threshold τ is selected to be a trough value (local minima of the probability distribution function). These can be troughs of the entire distribution, or of the conditional distributions of each class.

Peak: The scalar distribution of each class is estimated, for example from a Gaussian mixture model, and threshold τ is selected to be a peak value (local maxima of the probability distribution function). These can be peaks of the entire distribution, or of the conditional distributions of each class.

Discrimination maximization: For a given threshold τ and scale s, the conditional means m₀ and m₁ and variances v₀ and v₁ of f(x;τ,s) conditioned on class label is estimated, and from that a discrimination value d(τ,s)=(m₀−m₁)²/(v₀+v₁) is computed. One can then choose ti to maximize the sum discrimination d(τ,1)+d(τ,−1) of a “forward” and “backward” ReLU.

To each value of t obtained from the above rules, one can associate one or more scale values, as follows.

Unit scaling: s=1.

Bi-polar scaling: s₁=1, and s₂=−1, associated with τ₁=τ2=τ. Note that a GAU 430 with two outputs, having a positive and negative s_{y} associated with a common threshold τ, is an invertible mapping. Hence applying such a GAU 430 may not lose any information. The GAU mapping can exploit differences in distribution between the two classes, and via transformation, makes those differences more accessible to linear classifiers. Bi-polar scaling may be used in conjunction with the dimensions of the matrix of fixed weights being z/2 by z, such that the number of values in the output vector 412 is the same as the number of values in the input vector 402.

Accordingly, by at least one of the above mentioned methods the parameters for the plurality of activation unit functions may be selected based on the sample inputs and sample labels.

The processor 120 may apply the GAU functions with the selected parameters to the matrix unit output vectors to generate the output vectors 412, at S550.

The processor 120 may select linear filter parameters with the goal of predicting training labels based on the outputs of all of the GAUs 430 for each of the matrix unit output vectors and the input classifier values 404, at S560. The processor 120 may select the linear filter parameters using Fisher's linear discriminant analysis or another method known in the art.

The processor 120 may implement the linear filter such that the selected linear filter parameters are applied to the outputs of the GAUs 430 (values included in the output vectors 412) and the input classifier values 404 to generate a plurality of summands, at S570. The linear filter parameters may be applied to the outputs of the GAUs 430 by multiplying each of the outputs from the GAUs 430 and each of the input classifier values 404 by a corresponding one of the linear filter parameters to generate a plurality of summands associated with each of the input vectors. Each linear filter parameter is associated with one of the outputs of the GAUs 430 or the input classifier value 404. In an example embodiment, where each of GAUs 430 outputs multiple outputs for each matrix unit output vector, one linear filter parameter is associated with each of the outputs of each of the GAUs. One of the linear filter parameters is also associated with the input classifier value 404.

The processor 120 may also implement the linear filter 440 to generate an output classification value for each of the input vectors 402 input into the computation block 400. The linear filter 440 may generate the output classification value by summing all of the summands associated with the same input vector.

The processor 120 may determine whether the training of the neural network is complete, at S580. The processor 120 may determine whether the training is complete by different methods or by a combination of the different methods. For example, the processor 120 may determine the training of the neural network is complete if a desired (or, alternatively predetermined) number of computation blocks have been implemented. This may be determined by comparing k to a desired (or, alternatively predetermined) number.

The processor 120 may also determine whether the training is completed by determining if a target performance has been met. The processor 120 may determine if a target performance has been met by comparing the output labels 416 of the last computation block (for example, computation block N 350) with the sample identifiers, if the sample identifiers and the output labels match more than a desired (or, alternatively predetermined) threshold, the processor 120 may determine that the target performance has been met and the training is completed. Alternatively, the processor 120 may determine whether the target performance has been met by testing the neural network with a validation set of sample inputs not used in training the neural network, and comparing the output labels with the sample identifiers associated with the sample inputs in the validation set. If the sample identifiers and the output labels match more than a desired (or, alternatively predetermined) threshold, the processor 120 may determine that the target performance has been met and the training is completed.

The processor 120 may also determine whether the training is complete by determining whether the performance of the neural network has saturated. The processor 120 may determine whether the performance of the neural network has saturated by comparing the number of sample identifiers and the output labels 416 that match after a last computation block (for example, computation block N 350) and compare the number to the number of sample identifiers and output labels that matched after a previous computation block (for example, computation block N−1). If the number of matches has not improved by a desired (or, alternatively predetermined) threshold, the processor 120 may determine that the performance of the neural network has saturated.

During the process of training the neural network the processor 120 may store various values in the memory 110. For example, the processor 120 may store for each of the computation blocks the selected values for the matrix of fixed weights and the dimensions of the matrix of fixed weights, the function and parameters for each of the GAUs, the linear filter parameters, the decision threshold and a value representing the number of trained computation blocks.

In this way, example embodiments of the invention have the advantage of being adjustable and scalable according to the needs of a classification task. A maximum number of computation blocks can be selected by the desired (or, alternatively predetermined) number to which k is compared. Thus, the amount of computation time and power needed to implement the neural network may be controlled. This is particularly useful when applying this method to consumer electronics such as smartphones, and laptops where computation time and power usage are of great concern. For tasks where a certain level of accuracy is needed, the target performance may also be adjusted by setting the desired (or, alternatively predetermined) threshold. The benefits of additional computation blocks can also be assessed by determining if the performance has saturated. Thus, unnecessary computation blocks can be avoided and computation power can be preserved. These advantages are possible because of the feed forward manner in which the neural network is trained.

The neural network may be trained in a feed forward manner by data only passing forward from one computation block to the next computation block, rather than data from subsequent computation blocks being fed back into previous computation blocks in order to adjust the parameters of the previous computation blocks.

If the processor 120 determines that the training is complete, the processor 120 may proceed to classify the input to be classified. If the processor 120 determines that the training is not complete the processor 120 may implement computation block k+1 setting the output vectors 412 and the output classifier values 414 of computation block k as the input vectors 402 and the input classifier values 404 of the computation block k+1, respectively, at S590. The processor 120 may also set k=k+1, at S595 and return to S520.

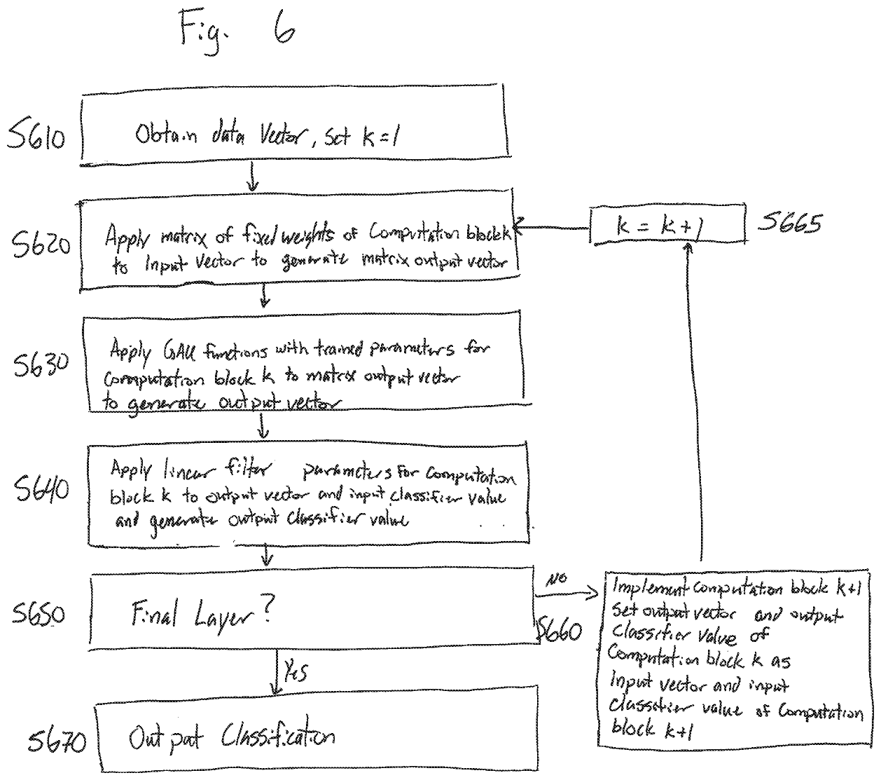

FIG. 6 is a flow diagram illustrating example computational operations performed to classify an input using a trained neural network.

The processor 120 may obtain a data vector based on the input to be classified and set the data vector as in input vector for the first computation block and set k=1, at S610. The processor 120 may also set the input classifier value of first computation block, at step S610. The input classifier value 404 for the first computation block may be set to the same value as the input classifier value 404 for training the first computation block.

The processor 120 may apply the matrix of fixed weights for the trained computation block associated with the value of k to the input vector 402 to generate the matrix output vector, at S620.

The processor 120 may apply the GAU functions with the trained parameters for the trained computation block associated with the value of k to the matrix output vector to generate the output vector 412, at S630.

The processor 120 may apply the linear filter parameters for the trained computation block associated with the value of k to the output vector 412 and the input classifier value 404 to generate the summands and generate the output classifier values based on the summands, at S640. The processor 120 may also generate the output label 416, at S640. The processor 120 may not generate the output label 416 for a computation block that is not the final computation block for the trained neural network.

The processor 120 may determine whether the final computation block has been implemented, at S650. The processor 120 may determine whether the final computation block has been implemented by comparing the value of k with the stored value representing the number of trained computation blocks. If the processor 120 determines that the final computation block has not been implemented the processor 120 may set the output vector and the output classifier value for the computation block associated with the value of k as the input vector and the input classifier value of the computation block associated with k+1, respectively, at S560. The processor 120 may then set k=k+1, at S665, and return to S620. If the processor 120 determines that the final computation block has not been implemented, then the processor 120 may return the output label 416 of the final computation block as the classification of the input to be classified, at S570.

The inventive concepts may also be implemented as a non-transitory computer readable medium which, when executed by a processor 120, cause the processor 120 to implement the operations as disclosed above.

The above described example embodiments may provide the advantage that computational power needed to train the neural network is reduced. The above described example embodiments may also provide the advantage of having a scalable neural network with a tradeoff between the classification accuracy and complexity of the neural network.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1. A method comprising:
obtaining, at an electronic device, an input to be classified;
training, at the electronic device, a neural network in a feed-forward manner based on a plurality of sample inputs and sample classifications, each of the sample classifications associated with one of the plurality of sample inputs, the training including, for each of a plurality of layers in the neural network, selecting values for a weight matrix, parameters for a plurality of activation unit functions, and a plurality of linear filter parameters; and
classifying, at the electronic device, the input using the trained neural network based on the weight matrix, the parameters for the plurality of activation unit functions, and the plurality of linear filter parameters for each of the plurality of layers.

2. The method of claim 1 wherein, the parameters for the plurality of activation unit functions are selected based on the sample inputs and sample labels.

3. The method of claim 2 wherein, the parameters for the plurality of activation unit functions are selected using at least one of
a midpoint between two randomly selected values output from the weight matrix,
a local minimum of a probability distribution function of at least some of the values output from the weight matrix using a Gaussian mixture model,
a local maximum of a probability distribution function of values output from the weight matrix using a Gaussian mixture model,
discrimination maximization based on variations in one of the parameters for the plurality of activation unit functions,
unit scaling, and
bi-polar scaling.

4. The method of claim 1, wherein the selecting of values of the weight matrix is performed independent of the sample inputs and sample labels.

5. The method of claim 1, wherein the values of the weight matrix are selected randomly.

6. The method of claim 1 further comprising:
storing, for each of the plurality of layers, the values for a weight matrix, the parameters for the plurality of activation unit functions, and the plurality of linear filter parameters.

7. The method of claim 1, wherein
the training further includes determining whether the training is complete, after implementing each of the plurality of layers.

8. The method of claim 1, wherein
the determining whether the training is complete is based on a threshold value associated with a number of layers implemented in the plurality of layers.

9. The method of claim 1, wherein
the determining whether the training is complete is based on a threshold associated with a target performance of the neural network.

10. The method of claim 1, wherein
the determining whether the training is complete includes determining whether performance of the neural network is saturated.

11. An electronic device comprising:
a memory configured to store program instruction; and
a processor configured to execute the program instruction,
wherein the memory the processor and the program instructions are configured to,
obtain an input to be classified,
train a neural network in a feed-forward manner based on a plurality of sample inputs and sample classifications, each of the sample classifications associated with one of the plurality of sample inputs, the training including, for each of a plurality of layers in the neural network, selecting values for a weight matrix, parameters for a plurality of activation unit functions, and a plurality of linear filter parameters, and
classify the input using the trained neural network based on the weight matrix, the parameters for the plurality of activation unit functions, and the plurality of linear filter parameters for each of the plurality of layers.

12. The electronic device of claim 11 wherein, the processor is further configured to select the parameters for the plurality of activation unit functions based on the sample inputs and sample labels.

13. The electronic device of claim 11, wherein the parameters for the plurality of activation unit functions are selected using at least one of
a midpoint between two randomly selected values output from the weight matrix,
a local minimum of a probability distribution function of at least some of the values output from the weight matrix using a Gaussian mixture model,
a local maximum of a probability distribution function of values output from the weight matrix using a Gaussian mixture model,
discrimination maximization based on variations in one of the parameters for the plurality of activation unit functions,
unit scaling, and
bi-polar scaling.

14. The electronic device of claim 11, wherein the processor is further configured to select the values for the weight matrix independently of the sample inputs and sample labels.

15. The electronic device of claim 11, wherein the processor is further configured to select the values of the weight matrix randomly.

16. The electronic device of claim 11, wherein the processor is further configured to
store, for each of the plurality of layers, the values for a weight matrix, the parameters for the plurality of activation unit functions, and the plurality of linear filter parameters, in the memory.

17. The electronic device of claim 11, wherein
the processor is configured to train the neural network by determining whether the training is complete, after implementing each of the plurality of layers.

18. The electronic device of claim 11, wherein
the processor is configured to determine whether the training is complete based on a threshold value associated with a number of layers implemented in the plurality of layers.

19. The electronic device of claim 11, wherein
the processor is configured to determine whether the training is complete based on a threshold associated with a target performance of the neural network.

20. The electronic device of claim 11, wherein
the processor is configured to determine whether the training is complete by determining whether the training is complete includes determining whether performance of the neural network is saturated.

21. A non-transitory computer readable medium including program instructions which, when executed by a processor, cause the processor to:
obtain an input to be classified;
train a neural network in a feed-forward manner based on a plurality of sample inputs and sample classifications, each of the sample classifications associated with one of the plurality of sample inputs, the training including, for each of a plurality of layers in the neural network, selecting values for a weight matrix, parameters for a plurality of activation unit functions, and a plurality of linear filter parameters; and
classify the input using the trained neural network based on the weight matrix, the parameters for the plurality of activation unit functions, and the plurality of linear filter parameters for each of the plurality of layers.
